(19) United States
(12) Patent Application Publication
(10) Pub. No.: US 2024/0124733 A1
(43) Pub. Date: Apr. 18, 2024

(54) AQUEOUS INK, INK JET RECORDING METHOD AND INK JET RECORDING APPARATUS

(71) Applicant: CANON KABUSHIKI KAISHA, Tokyo (JP)

(72) Inventors: KAZUYA NUSHIRO, Tokyo (JP); YOSHIHIDE AIKAWA, Kanagawa (JP); AKIRA KURIYAMA, Kanagawa (JP); MASANORI YOSHIDA, Chiba (JP)

(21) Appl. No.: 18/486,453

(22) Filed: Oct. 13, 2023

(30) Foreign Application Priority Data
Oct. 18, 2022 (JP) 2022-167227
Oct. 2, 2023 (JP) 2023-171092

(51) Int. Cl. C09D 11/326; C09D 11/107

(52) U.S. Cl. CPC C09D 11/326; C09D 11/107

(57) ABSTRACT

Provided is an aqueous ink for ink jet capable of recording an image that is excellent in abrasion resistance immediately after recording and glossiness. The aqueous ink for ink jet includes: a coloring material dispersed by an action of an anionic group, a resin particle and a wax particle dispersed by a dispersant. A resin for forming the resin particle includes a unit having a cyano group and a volume-based 50% cumulative particle diameter D_{w} of the wax particle is larger than a volume-based 50% cumulative particle diameter D_{c} of the coloring material and a volume-based 50% cumulative particle diameter Dᵣ of the resin particle.

### BACKGROUND OF THE INVENTION

### Field of the Invention

The present invention relates to an aqueous ink, an ink jet recording method and an ink jet recording apparatus.

### Description of the Related Art

As a coloring material of an aqueous ink for ink jet, there are given a dye and a pigment. When an ink including, as a coloring material, a pigment (hereinafter sometimes referred to as “pigment ink”) out of those coloring materials is used, an image excellent in robustness is obtained. Meanwhile, the pigment ink has a problem in that a pigment particle is fixed in the vicinity of the surface of a recording medium to develop a color and hence the pigment ink is, in principle, inferior in abrasion resistance and glossiness of the image to an ink including, as a coloring material, a dye (hereinafter sometimes referred to as “dye ink”).

In view of the above-mentioned problem, in Japanese Patent Application Laid-Open No. 2016-145313, there is a proposal that a wax particle is incorporated in a pigment ink to improve the abrasion resistance of an image to be recorded. In addition, in Japanese Patent Application Laid-Open No. 2019-203044, there is a proposal of a pigment ink in which a self-dispersible pigment, a wax particle and a polyoxyethylene alkyl ether are incorporated and which is thus capable of recording an image that achieves both of color developability and abrasion resistance.

### SUMMARY OF THE INVENTION

However, the ink described in Japanese Patent Application Laid-Open No. 2016-145313 used a wax particle having a small particle diameter and hence particularly the abrasion resistance of the image was insufficient immediately after recording. In addition, with regard to the ink described in Japanese Patent Application Laid-Open No. 2019-203044, when a wax particle having a large particle diameter was used, an image to be recorded showed excellent abrasion resistance, but was insufficient in glossiness.

Accordingly, an object of the present invention is to provide an aqueous ink that can record an image with excellent abrasion resistance and glossiness immediately after recording. In addition, another object of the present invention is to provide an ink jet recording method and an ink jet recording apparatus each using the aqueous ink.

That is, according to the present invention, there is provided an aqueous ink for ink jet including: a coloring material dispersed by an action of an anionic group, a resin particle and a wax particle dispersed by a dispersant, wherein a resin for forming the resin particle includes a unit having a cyano group, and wherein a volume-based 50% cumulative particle diameter D_{w} of the wax particle is larger than a volume-based 50% cumulative particle diameter D_{c} of the coloring material and a volume-based 50% cumulative particle diameter Dᵣ of the resin particle.

Further features of the present invention will become apparent from the following description of exemplary embodiments with reference to the attached drawings.

### BRIEF DESCRIPTION OF THE DRAWINGS

FIG. 1 is a schematic view for illustrating an ink jet recording apparatus according to one embodiment of the present invention.

FIG. 2 is a perspective view for illustrating an example of a liquid applying device.

### DESCRIPTION OF THE EMBODIMENTS

The present invention is described in more detail below by way of exemplary embodiments. In the present invention, when a compound is a salt, the salt is present as dissociated ions in an ink, but the expression “contain a salt” is used for convenience. In addition, an aqueous ink and reaction liquid for ink jet are sometimes referred to simply as “ink” and “reaction liquid”. The volume-based 50% cumulative particle diameter is sometimes referred to “volume-average particle diameter (D50)” and “particle diameter”. Physical property values are values at normal temperature (25° C.), unless otherwise stated. The descriptions “(meth)acrylic acid” and “(meth)acrylate” refer to “acrylic acid or methacrylic acid” and “acrylate or methacrylate”, respectively. In the present invention, “unit” constituting a resin refers to a repeating unit derived from one monomer.

The inventors of the present invention have assumed the reason why the abrasion resistance of the image recorded with the pigment ink described in Japanese Patent Application Laid-Open No. 2016-145313 is insufficient to be as described below. That is, on a recording medium immediately after recording, the degree of sinking of a pigment and the wax particle is low and a large portion of the pigment and the wax particle remains on the surface of the recording medium. Accordingly, when an abrasion action is performed in the case where the particle diameter of the wax particle is smaller than the particle diameter of the pigment, a pigment particle, which has a higher degree of exposure, is preferentially abraded. Accordingly, in order to develop excellent abrasion resistance immediately after recording, it is required that the particle diameter of the wax particle be set to be larger than the particle diameter of the pigment.

With regard to the pigment ink described in Japanese Patent Application Laid-Open No. 2019-203044, when a wax particle having a larger particle diameter than that of the pigment was used, an image to be recorded showed excellent abrasion resistance even immediately after recording, but was insufficient in glossiness. The inventors have assumed the reason for the insufficient glossiness to be as described below. In the ink described in Japanese Patent Application Laid-Open No. 2019-203044, the abrasion resistance is improved by causing the self-dispersible pigment and the wax particle to adsorb to each other via the polyoxyethylene alkyl ether. In this case, pigment particles are liable to aggregate with each other and hence a portion in which the wax particles excessively aggregate with each other is also partly present. It is conceived that, in this case, partly because of the fact that the wax particle has a larger particle diameter than that of the pigment, the glossiness is reduced owing to an increase in influence of scattered light.

The inventors have investigated the related-art pigment inks as described above and as a result, have conceived that it is important to use a wax particle having a larger volume-based 50% cumulative particle diameter (hereinafter sometimes referred to as “volume-average particle diameter”) than that of a coloring material for improving the abrasion resistance of an image. The inventors have also conceived that it is important to suppress excessive aggregation of the wax particles, to thereby reduce the influence of the scattered light for improving the glossiness of the image. That is, the inventors have expected that, even when the wax particles having a larger volume-average particle diameter than that of the coloring material are used, the glossiness can be improved by unevenly distributing the wax particles on a recording medium, to thereby suppress the scattered light. The inventors have made investigations based on the expectation and as a result, have found that, when a resin particle formed of a resin including a unit having a cyano group is incorporated in an ink, the glossiness of the image is significantly improved. In addition, the inventors have found that not only the glossiness but also the abrasion resistance is improved in this case contrary to expectations.

An assumed mechanism for improving the glossiness and abrasion resistance of the image by further adding the resin particle including a unit having a cyano group to the ink including the coloring material and the wax particle having a larger volume-average particle diameter than that of the coloring material is described below.

First, the inventors have presumed a mechanism for improving the glossiness to be as described below. The unit having a cyano group in a resin for forming the resin particle has a highly polarized structure because of its cyano group (nitrile moiety) and is expected to interact with a material having a polarized structure or a polar moiety. When the wax particle is used as a component of an aqueous ink, a dispersant is used in order to disperse the wax particle in the ink. The dispersant has a polar moiety, such as an anionic moiety or a nonionic moiety, in order to disperse the wax particle, which is hydrophobic, in an aqueous medium. It is presumed that, when the polar moiety of the dispersant for dispersing the wax particle interacts with the nitrile moiety of the resin for forming the resin particle, the wax particles are unevenly distributed through expansion of an interparticle distance thereof and thus the glossiness of the image is improved.

The uneven distribution of particles caused by the resin particle formed of a resin including a unit having a cyano group may have a similar effect not only on the wax particle but also on the coloring material such as a pigment. In order to use the coloring material such as a pigment as a component of the aqueous ink, it is required that the coloring material be stably dispersed in the aqueous medium. In this case, there is a method of stably dispersing the coloring material by imparting polarity to a dispersion group thereof to cause charge repulsion. The inventors have made investigations and as a result, have found that, when a coloring material using an anionic group as a dispersion group and the resin particle formed of a resin including a unit having a cyano group are caused to coexist, the glossiness of the image is improved. This is presumably because the coloring material and the resin particle interact with each other in the same manner as in the case of the wax particle and the resin particle is thus present between particles of the coloring material, to thereby suppress excessive aggregation of the coloring material, with the result that scattered light or bronze light derived from the coloring material is reduced.

As described above, the resin particle formed of a resin including a unit having a cyano group may interact with each of the wax particle dispersed by the dispersant and the coloring material dispersed by the action of an anionic group. It is inferred that the interaction causes the wax particle and the coloring material to be unevenly distributed, to thereby suppress the scattered light, with the result that the glossiness of the image is improved.

Next, the inventors have presumed a mechanism for improving the abrasion resistance of the image immediately after recording by incorporating the resin particle formed of a resin including a unit having a cyano group in the ink to be as described below. The inventors have analyzed the surface of the image and as a result, have found that the wax particles are present in an unevenly distributed manner in the image excellent in abrasion resistance. That is, in order to improve the abrasion resistance of the image, it is required that the wax particle be efficiently arranged in a portion to be abraded. As described above, when the resin particle formed of a resin including a unit having a cyano group is used, it is expected that the wax particles are present in an unevenly distributed manner. Accordingly, it is inferred that, when the resin particle having a smaller volume-average particle diameter than that of the volume-average particle diameter of the wax particles is used, the wax particles can be more efficiently unevenly distributed on the recording medium and thus the abrasion resistance of the image is improved.

(Ink)

An ink of the present invention is an aqueous ink for ink jet including: a coloring material dispersed by the action of an anionic group, a resin particle formed of a resin including a unit having a cyano group and a wax particle dispersed by a dispersant. Moreover, the ink needs to satisfy the following: the volume-based 50% cumulative particle diameter D_{w} of the wax particle is larger than the volume-based 50% cumulative particle diameter D_{c} of the coloring material and the volume-based 50% cumulative particle diameter Dᵣ of the resin particle. Components used in the ink and the like are described in detail below.

[Coloring Material]

The ink includes a coloring material that are dispersed by the action of an anionic group. As the coloring material, it is possible to mention one that is dispersed in the aqueous ink by an anionic group, such as a pigment or a resin particle containing a dye. Of such coloring materials, a coloring material dispersed by the action of a carboxylic acid group is preferred. One or two or more kinds of coloring materials may be incorporated into the ink. The content (% by mass) of the coloring material in the ink is preferably 0.5% by mass or more to 15.0% by mass or less, more preferably 1.0% by mass or more to 10.0% by mass or less with respect to the total mass of the ink.

Specific examples of the pigment may include: inorganic pigments, such as carbon black and titanium oxide and organic pigments, such as azo, phthalocyanine, quinacridone, isoindolinone, imidazolone, diketopyrrolopyrrole and dioxazine pigments. The pigments may be used alone or in combination thereof.

A resin-dispersed pigment using a resin as a dispersant, a self-dispersible pigment, which has a hydrophilic group bonded to its particle surface, or the like may be used as a dispersion system for the pigment. In addition, a resin-bonded pigment having a resin-containing organic group chemically bonded to its particle surface, a microcapsule pigment, which contains a particle whose surface is covered with, for example, a resin, or the like may be used. Pigments different from each other in dispersion system out of those pigments may be used in combination. In the present invention, not a resin-bonded pigment or a microcapsule pigment but a resin-dispersed pigment having resin as dispersant to physically adsorb to its particle surface of pigment or a self-dispersible pigment having a hydrophilic group bonded to its particle surface is preferably used.

A dispersant that can disperse the pigment in an aqueous medium by the action of an anionic group is preferably used as a resin dispersant for dispersing the pigment in the aqueous medium. A resin having an anionic group may be used as the resin dispersant and such a resin as described later, in particular, a water-soluble resin is preferably used. Furthermore, a pigment that is dispersed by the action of water-soluble resin having carboxylic acid group is preferred. The mass ratio of the content (% by mass) of the pigment in the ink to the content (% by mass) of the resin dispersant is preferably 0.3 times or more to 10.0 times or less.

A pigment having an anionic group bonded to its particle surface directly or through any other atomic group (—R—) may be used as the self-dispersible pigment. Among them, those in which the carboxylic acid group is bonded directly or via other atomic group (—R—) to the surface of the pigment particle are preferred. The anionic group may be any one of an acid type or a salt type. When the group is a salt type, the group may be in any one of a state in which part of the group dissociates or a state in which the entirety thereof dissociates. When the anionic group is a salt type, examples of a cation serving as a counterion may include an alkali metal cation, ammonium and an organic ammonium. Specific examples of the other atomic group (—R—) may include: a linear or branched alkylene group having 1 to 12 carbon atoms, an arylene group, such as a phenylene group or a naphthylene group, a carbonyl group, an imino group, an amide group, a sulfonyl group, an ester group and an ether group. In addition, groups obtained by combining those groups may be adopted. When a self-dispersion pigment is used as the coloring material, a pigment having an anionic group (suitably a carboxylic acid group) bonded to its particle surface through any other atomic group is preferably used. Of such pigments, a self-dispersion pigment having —C₆H₃—(COOM)₂ (phthalic acid structure; M represents the cation that serves as the counter ion) bonded to its particle surface is particularly preferred.

A dye having an anionic group can be used as the dye. Specific examples of the dye may include dyes, such as azo, triphenylmethane, (aza)phthalocyanine, xanthene and anthrapyridone dyes. The dyes may be used alone or in combination thereof. The coloring material is preferably a pigment, more preferably a resin-dispersed pigment or a self-dispersible pigment and particularly preferably a resin-dispersed pigment.

Examples of the anionic group described in the description of the resin dispersant, the self-dispersing pigment, and the dye includes a carboxylic acid group, a sulfonic acid group and a phosphonic acid group. The anionic group may be either an acid type or a salt type, and in the case of a salt type, it may be either partially dissociated or fully dissociated. In the case where the anionic group is a salt type, alkali metal cations, ammonium, organic ammonium, and the like can be mentioned as cations serving as counter ions.

[Water-soluble Resin]

A water-soluble resin that can be dissolved in an aqueous medium may be incorporated into the ink. The content (% by mass) of the water-soluble resin in the ink is preferably 0.1% by mass or more to 20.0% by mass or less, more preferably 0.5% by mass or more to 15.0% by mass or less with respect to the total mass of the ink.

The water-soluble resin may be added to the ink (i) for stabilizing the dispersed state of the pigment, that is, as a resin dispersant or an aid therefor. In addition, the resin may be added to the ink (ii) for improving the various characteristics of an image to be recorded. Examples of the form of the water-soluble resin may include a block copolymer, a random copolymer, a graft copolymer and a combination thereof. The resins may be used alone or in combination thereof.

[Composition of Resin]

Examples of the water-soluble resin may include an acrylic resin, a urethane-based resin and an olefin-based resin. Of those, an acrylic resin and a urethane-based resin are preferred and an acrylic resin including a unit derived from (meth)acrylic acid or a (meth)acrylate is more preferred.

A resin having a hydrophilic unit and a hydrophobic unit as its structural units is preferred as the acrylic resin. Of those, a resin having a hydrophilic unit derived from (meth)acrylic acid and a hydrophobic unit derived from at least one selected from a group consisting of a monomer having an aromatic ring and a (meth)acrylic acid ester-based monomer is preferred. A resin having a hydrophilic unit derived from (meth)acrylic acid and a hydrophobic unit derived from at least one selected from a group consisting of a monomer of styrene and α-methylstyrene is particularly preferred. Those resins may each be suitably utilized as a resin dispersant for dispersing the pigment because the resins each easily cause an interaction with the pigment.

The hydrophilic unit is a unit having a hydrophilic group such as an anionic group. The hydrophilic unit may be formed by, for example, polymerizing a hydrophilic monomer having a hydrophilic group. Specific examples of the hydrophilic monomer having a hydrophilic group may include: acidic monomers each having a carboxylic acid group, such as (meth)acrylic acid, itaconic acid, maleic acid and fumaric acid and anionic monomers, such as anhydrides and salts of these acidic monomers. A cation for forming the salt of the acidic monomer may be, for example, a lithium, sodium, potassium, ammonium or organic ammonium ion. The hydrophobic unit is a unit free of a hydrophilic group such as an anionic group. The hydrophobic unit may be formed by, for example, polymerizing the hydrophobic monomer free of a hydrophilic group such as anionic group. Specific examples of the hydrophobic monomer may include: monomers each having an aromatic ring, such as styrene, α-methylstyrene and benzyl (meth)acrylate and (meth)acrylic acid ester-based monomers, such as methyl (meth)acrylate, butyl (meth)acrylate and 2-ethylhexyl (meth)acrylate.

The urethane-based resin may be obtained by, for example, causing a polyisocyanate and a polyol to react with each other. In addition, a chain extender may be further caused to react with the reaction product. Examples of the olefin-based resin may include polyethylene and polypropylene.

[Properties of Resin]

The phrase “resin is water-soluble” as used herein means that when the resin is neutralized with an alkali whose amount is equivalent to its acid value, the resin is present in an aqueous medium under a state in which the resin does not form any particle whose particle diameter may be measured by a dynamic light scattering method. Whether or not the resin is water-soluble can be judged in accordance with the following method. First, a liquid (resin solid content: 10% by mass) containing the resin neutralized with an alkali (e.g., sodium hydroxide or potassium hydroxide) corresponding to its acid value is prepared. Next, the prepared liquid is diluted with pure water tenfold (on a volume basis) to prepare a sample solution. Then, when no particle having a particle diameter is measured at the time of the measurement of the particle diameter of the resin in the sample solution by the dynamic light scattering method, the resin can be judged to be water-soluble. Measurement conditions at this time may be set, for example, as follows: SetZero: 30 seconds, number of times of measurement: 3 and measurement time: 180 seconds. In addition, a particle size analyzer based on the dynamic light scattering method (e.g., an analyzer available under the product name “UPA-EX150” from Nikkiso Co., Ltd.) or the like may be used as a particle size distribution measuring device. Of course, the particle size distribution measuring device to be used, the measurement conditions and the like are not limited to the foregoing.

The acid value of the water-soluble resin is preferably 100 mgKOH/g or more to 250 mgKOH/g or less. The weight-average molecular weight of the water-soluble resin is preferably 3,000 or more to 15,000 or less.

[Resin Particle]

The ink includes the resin particle. The term “resin particle” as used herein means a resin, which is dispersed in an aqueous medium and can be present in the aqueous medium under the state of having a particle diameter. Accordingly, the resin particle is present under the state of being dispersed in the ink, that is, a resin emulsion state. In addition, the resin particle may include a coloring material (e.g., a dye, a pigment or an invisible coloring material that develops a color through fluorescence or the like) or may not include any coloring material. The resin particle may be a single-layer particle or may be formed from a plurality of layers. The resin particle is preferably a single-layer particle, that is, a particle free of any core-shell structure out of such particles.

Whether or not a resin is the “resin particle” may be determined in accordance with a method to be described below. First, a liquid (resin solid content: 10% by mass) containing a resin neutralized with an alkali (e.g., sodium hydroxide or potassium hydroxide) corresponding to its acid value is prepared. Next, the prepared liquid is diluted 10-fold (based on a volume) with pure water to prepare a sample solution. Then, when a particle having a particle diameter is measured at the time of the measurement of the particle diameter of the resin in the sample solution by a dynamic light scattering method, the resin can be determined to be the “resin particle”. A particle size analyzer (e.g., a product available under the product name “UPA-EX 150” from Nikkiso Co., Ltd.) or the like may be used as a particle size distribution-measuring device using the dynamic light scattering method. Measurement conditions in this case may be set, for example, as follows: SetZero: 30 seconds, number of times of measurement: 3 times, measurement time: 180 seconds, shape: perfect spherical shape and refractive index: 1.59. Needless to say, the particle size distribution-measuring device, the measurement conditions, and the like to be used are not limited to the foregoing. The purpose of measuring the particle diameter through use of the neutralized resin is to recognize that a particle is formed even when the resin is sufficiently neutralized to make it more difficult to form a particle. The resin having a particle shape even under such conditions is present under the state of a particle even in an aqueous ink.

The resin for forming the resin particle includes the unit having a cyano group (also referred to as “nitrile group”). A monomer that is turned into the unit having a cyano group by polymerization is preferably a monomer, which has a cyano group and has one polymerizable functional group such as an ethylenically unsaturated bond in a molecule thereof, more preferably an ethylenically unsaturated monomer having a cyano group. Accordingly, the unit having a cyano group is more preferably a unit derived from an ethylenically unsaturated monomer having a cyano group.

Examples of the monomer for forming the unit having a cyano group may include acrylonitrile, methacrylonitrile, chloroacrylonitrile and 2-cyanoethyl (meth)acrylate. Those monomers may be used alone or in combination thereof. Acrylonitrile and methacrylonitrile are preferred because the glossiness of an image can be further improved. That is, the unit having a cyano group is preferably a unit derived from at least one kind of monomer selected from the group consisting of: acrylonitrile and methacrylonitrile.

A ratio (% by mass) of the unit having a cyano group to the resin for forming the resin particle is preferably 10.0% by mass or more with respect to the total mass of the resin. When the ratio of the unit having a cyano group is 10.0% by mass or more, the glossiness of the image can be further improved. This is presumably because, when the ratio of the unit having a cyano group to the resin is 10.0% by mass or more, the resin particle easily interacts with each of the wax particle and the coloring material and hence the respective particles can be unevenly distributed. The ratio of the unit having a cyano group is preferably 40.0% by mass or less, more preferably 30.0% by mass or less.

The resin for forming the resin particle may include any other unit (other unit) than the unit having a cyano group. The resin for forming the resin particle preferably includes a hydrophilic unit and a hydrophobic unit as the other units. Of resins each including such units, a resin including a hydrophilic unit derived from (meth)acrylic acid and a hydrophobic unit derived from at least one kind selected from the group consisting of: a monomer having an aromatic ring and a (meth)acrylic acid ester-based monomer is more preferred. In particular, the resin for forming the resin particle still more preferably includes a unit having an aromatic group as the hydrophobic unit. When the resin for forming the resin particle includes the unit having an aromatic group, the abrasion resistance of the image can be further improved. This is presumably because the unit having an aromatic group in the resin for forming the resin particle has a structure having high planarity and is hence bonded more firmly to an aromatic ring of the coloring material through π-π interaction. The ratio (% by mass) of the unit having an aromatic group to the resin for forming the resin particle is preferably 20.0% by mass or more to 50.0% by mass or less, more preferably 30.0% by mass or more to 45.0% by mass or less with respect to the total mass of the resin.

The hydrophilic unit is a unit having a hydrophilic group such as an anionic group. Examples of the anionic group include a carboxylic acid group, a phenolic hydroxy group, a phosphoric acid ester group and a sulfate ester group. A monomer that is turned into the unit having a hydrophilic group by polymerization is preferably a monomer, which has an anionic group and has one polymerizable functional group such as an ethylenically unsaturated bond in a molecule thereof, more preferably an ethylenically unsaturated monomer having an anionic group. Such monomers may be used alone or in combination thereof. Examples of the monomer include: acidic monomers each having a carboxylic acid group, such as (meth)acrylic acid, itaconic acid, maleic acid and fumaric acid and anionic monomers, such as anhydrides or salts of these acidic monomers. Examples of cations for forming the salts of the acidic monomers include ions of lithium, sodium, potassium, ammonium and an organic ammonium.

The resin for forming the resin particle preferably includes a unit having a sulfate ester group as the hydrophilic unit. When the resin for forming the resin particle includes the unit having a sulfate ester group (—O—SO₃⁻), the abrasion resistance of the image can be further improved. This is presumably because, when a sulfate ester group, which has a high dissociation constant, is present in the resin for forming the resin particle, the uneven distribution of the resin particles is promoted through charge repulsion between the resin particles. In addition, the carboxylic acid group and the sulfate ester group may be used in combination as the anionic groups included in the hydrophilic unit of the resin for forming the resin particle.

A preferred monomer to be polymerized into the unit having a sulfate ester group is an ether sulfate ester salt having a sulfate ester group and also having one polymerizable functional group such as an ethylenically unsaturated bond in a molecule thereof. An ether sulfate ester salt-type reactive surfactant having radical polymerizability may be preferably used as the monomer for forming the unit having a sulfate ester group. An example thereof is a polyoxyalkylene alkenyl ether sulfate ester salt such as an ammonium polyoxyalkylene alkenyl ether sulfate.

The ratio (% by mass) of the hydrophilic unit serving as the other unit to the resin for forming the resin particle is preferably 5.0% by mass or more to 30.0% by mass or less, more preferably 10.0% by mass or more to 25.0% by mass or less with respect to the total mass of the resin. When the above-mentioned ratio (% by mass) of the hydrophilic unit is 5.0% by mass or more, the ejection characteristic of the ink is easily improved. Meanwhile, when the above-mentioned ratio (% by mass) of the unit having an anionic group is 30.0% by mass or less, the hydrophilicity of the resin particle is moderately suppressed and hence the abrasion resistance of an image is easily improved.

The hydrophobic unit is a unit free of a hydrophilic group such as an anionic group. The hydrophobic unit may be formed by, for example, polymerizing a hydrophobic monomer free of a hydrophilic group such as an anionic group. As described above, specific examples of the hydrophobic monomer include a monomer having an aromatic ring and a (meth)acrylic acid ester-based monomer. Examples of the monomer having an aromatic ring include styrene, 4-methyl styrene and 2-chlorostyrene. Examples of the (meth)acrylic acid ester-based monomer include methyl (meth)acrylate, ethyl (meth)acrylate, butyl (meth)acrylate and 2-ethylhexyl (meth)acrylate. The hydrophobic monomers may be used alone or in combination thereof.

The ratio (% by mass) of the hydrophobic unit serving as the other unit to the resin for forming the resin particle is preferably 30.0% by mass or more to 85.0% by mass or less, more preferably 45.0% by mass or more to 70.0% by mass or less with respect to the total mass of the resin.

The content (% by mass) of the resin particle in the ink is preferably 1.0% by mass or more to 15.0% by mass or less, more preferably 1.0% by mass or more to 12.0% by mass or less with respect to the total mass of the ink.

The glass transition temperature (° C.) of the resin particle is preferably 40° C. or more to 110° C. or less. When the glass transition temperature of the resin particle is 40° C. or more, the blocking resistance of the image is easily improved. Meanwhile, when the glass transition temperature of the resin particle is 110° C. or less, the binding property of the resin particle to a recording medium is strengthened and hence the abrasion resistance of the image is easily improved. The glass transition temperature of the resin particle is more preferably 45° C. or more to 90° C. or less, still more preferably 50° C. or more to 80° C. or less. The glass transition temperature of the resin particle may be measured with a differential scanning calorimeter (e.g., a product available under the product name “DSC Q1000” from TA Instruments, Inc.).

The acid value of the resin for forming the resin particle is preferably 5 mgKOH/g or more to 100 mgKOH/g or less. The weight-average molecular weight of the resin for forming the resin particle is preferably 1,000 or more to 2,000,000 or less.

[Method of Producing Resin Particle]

The resin particle may be produced in accordance with a conventionally known method, such as an emulsion polymerization method, a mini-emulsion polymerization method, a seed polymerization method or a phase inversion emulsification method.

[Method of Verifying Resin Particle]

The configuration of a resin particle may be verified in accordance with a method described in the following sections (i) and (ii). A method including extracting a resin particle from an ink and analyzing and verifying the resin particle is described below, but a resin particle extracted from an aqueous dispersion liquid or the like may also be analyzed and verified in the same manner.

(i) Extraction of Resin Particle

A resin particle may be separated and extracted from an ink including the resin particle by a density gradient centrifugation method. The resin particle is separated and extracted based on a difference in sedimentation coefficient of components in a density gradient sedimentation velocity method out of the density gradient centrifugation methods. In addition, the resin particle is separated and extracted based on a difference in density of components in a density gradient sedimentation equilibrium method out of the density gradient centrifugation methods.

(ii) Analysis of Unit (Monomer) for Forming Resin

The resin particle to be used as a sample may be in a state of a dispersion liquid. In addition, a resin particle in a state of being dried and formed into a film may also be used as a sample. A resin to be used as a sample is subjected to elemental analysis by a combustion method. Separately from the foregoing, the fractionated resin is subjected to pretreatment by an acid decomposition (hydrofluoric acid addition) method or an alkali fusion method and then an inorganic component is quantitatively analyzed by inductively coupled plasma emission spectroscopy. In addition, the kinds and ratios of the units (monomers) for forming the resin may be known by nuclear magnetic resonance (NMR) spectroscopy.

[Wax Particle]

The ink contains a wax particle dispersed in the ink by a dispersant. The wax particle is particles formed of a wax. The wax in this specification may be a composition blended with a component except the wax or may be the wax itself. The waxes may be used alone or in combination thereof.

The wax is an ester of a higher monohydric or dihydric alcohol that is insoluble in water and a fatty acid in a narrow sense. Accordingly, animal-based waxes and plant-based waxes are included in the category of the wax but oils and fats are not included therein. High-melting point fats, mineral-based waxes, petroleum-based waxes and blends and modified products of various waxes are included therein in a broad sense. In the present invention, the waxes in a broad sense may each be used without any particular limitation. The waxes in a broad sense may be classified into natural waxes, synthetic waxes, blends thereof (blended waxes) and modified products thereof (modified waxes).

Examples of the natural wax may include: animal-based waxes, such as beeswax, a spermaceti wax and lanolin, plant-based waxes, such as a Japan wax, a carnauba wax, a sugar cane wax, a palm wax, a candelilla wax and a rice wax, mineral-based waxes such as a montan wax and petroleum-based waxes, such as a paraffin wax, a microcrystalline wax and petrolatum. Examples of the synthetic wax may include hydrocarbon-based waxes, such as a Fischer-Tropsch wax and polyolefin waxes (e.g., polyethylene wax and polypropylene wax). The blended waxes are mixtures of the above-mentioned various waxes. The modified waxes are obtained by subjecting the above-mentioned various waxes to modification treatment, such as oxidation, hydrogenation, alcohol modification, acrylic modification or urethane modification. The above-mentioned waxes may be used alone or in combination thereof. The wax is preferably at least one kind selected from the group consisting of: a microcrystalline wax, a Fischer-Tropsch wax, a polyolefin wax, a paraffin wax and modified products and blends thereof. Of those, a blend of a plurality of kinds of waxes is more preferred and a blend of a petroleum-based wax and a synthetic wax is particularly preferred.

The acid value (mgKOH/g) of the wax particle is preferably 5 mgKOH/g or more from the viewpoint of improving the glossiness of the image. It is conceived that, when a wax particle having an acid value of 5 mgKOH/g or more is used, the wax particle sufficiently interacts with each of the resin particle and the coloring material and both the wax particle and the coloring material are easily unevenly distributed. The acid value of the wax particle is preferably 80 mgKOH/g or less, more preferably 50 mgKOH/g or less. The term “acid value” as used herein represents the acid value of the wax particle in a dispersed state and is derived from an anionic group in the wax or the dispersant. The acid value of the wax particle may be determined through potentiometric titration. The acid value of the wax particle in Examples described below is a value measured through potentiometric titration.

The wax is preferably a solid at normal temperature (25° C.). The melting point (° C.) of the wax is preferably 40° C. or more to 120° C. or less, more preferably 50° C. or more to 100° C. or less. The melting point of the wax may be measured in conformity with a test method described in the section 5.3.1 (Melting Point Testing Method) of JIS K 2235:1991 (Petroleum Waxes). In the cases of a microcrystalline wax, petrolatum and a mixture of a plurality of kinds of waxes, their melting points may be measured with higher accuracy by utilizing a test method described in the section 5.3.2 thereof. The melting point of the wax is susceptible to characteristics, such as a molecular weight (a larger molecular weight provides a higher melting point), a molecular structure (a linear structure provides a higher melting point but a branched structure provides a lower melting point), crystallinity (higher crystallinity provides a higher melting point) and a density (a higher density provides a higher melting point). Accordingly, the control of those characteristics can provide a wax having a desired melting point. The melting point of the wax in the ink may be measured, for example, as follows: after the wax fractionated by subjecting the ink to ultracentrifugation treatment has been washed and dried, its melting point is measured in conformity with each of the above-mentioned test methods.

A dispersant, such as a surfactant or a resin, may be used as a dispersant for dispersing the wax in the ink. In particular, an anionic dispersant and a nonionic dispersant are preferably used in combination.

Examples of the anionic dispersant may include an anionic surfactant and a resin having an anionic functional group. Examples of the anionic functional group may include a sulfonic acid group, a carboxylic acid group and a phosphoric acid group. Examples of the anionic surfactant may include a linear higher carboxylic acid (salt), a sulfonic acid (salt), an alkylbenzene sulfonate, an alkyl sulfate, a polyoxyethylene alkyl sulfate, an alkyl phosphate and a resin having an anionic functional group. Of those, an ethylene-acrylic acid copolymer is preferred because the copolymer enables stable dispersion of the wax particle by efficiently charging the surface of the wax.

Examples of the nonionic dispersant may include nonionic surfactants such as a polyoxyethylene alkyl ether and a polyoxyethylene alkenyl ether. Those nonionic surfactants each have a structure divided into a hydrophobic moiety (an alkyl group or an alkenyl group) and a hydrophilic moiety (an ethylene oxide chain). The nonionic surfactant enables stable dispersion of the wax particle by causing the hydrophobic moiety to efficiently adsorb to the wax particle and by causing the hydrophilic moiety to have an affinity for an aqueous medium. The hydrophobic moiety (an alkyl group or an alkenyl group) preferably has 10 or more to 30 or less carbon atoms. In addition, the number of ethylene oxide groups in the hydrophilic moiety is preferably 4 or more to 100 or less, more preferably 8 or more to 50 or less.

The content (% by mass) of the wax in the ink is preferably 0.1% by mass or more to 10.0% by mass or less, more preferably 0.3% by mass or more to 5.0% by mass or less with respect to the total mass of the ink. In addition, the content (% by mass) of the dispersant for dispersing the wax in the ink is preferably 0.1% by mass or more to 5.0% by mass or less with respect to the total mass of the ink. The content (% by mass) of the wax particle in the ink is preferably 0.2% by mass or more to 12.0% by mass or less, more preferably 0.5% by mass or more to 10.0% by mass or less with respect to the total mass of the ink. The content of the wax particle is the total content of the wax and the dispersant for dispersing the wax. In the case of a wax dispersible without the dispersant for dispersing the wax, the content of the “wax particle” is equal to the content of the “wax”.

(Volume-Based 50% Cumulative Particle Diameter)

The ink of the present invention needs to satisfy the following in order to develop excellent abrasion resistance: the volume-based 50% cumulative particle diameter D_{w} of the wax particle is larger than the volume-based 50% cumulative particle diameter D_{c} of the coloring material and the volume-based 50% cumulative particle diameter Dᵣ of the resin particle. Further, from the viewpoint of improving the glossiness of the image, the volume-based 50% cumulative particle diameter D_{c} of the coloring material is preferably equal to or larger than the volume-based 50% cumulative particle diameter Dᵣ of the resin particle. That is, the volume-based 50% cumulative particle diameter D_{c} of the coloring material, the volume-based 50% cumulative particle diameter D_{w} of the wax particle and the volume-based 50% cumulative particle diameter Dᵣ of the resin particle preferably satisfy the following relationship: Dᵣ≤D_{c}<D_{w}. When the volume-average particle diameter of the resin particle is equal to or smaller than the volume-average particle diameter of the coloring material, an influence of scattered light is reduced and thus the glossiness of the image can be further improved.

The volume-based 50% cumulative particle diameter D_{c} (nm) of the coloring material is preferably 40 nm or more to 400 nm or less, more preferably 50 nm or more to 300 nm or less, particularly more preferably 50 nm or more to 200 nm or less. In addition, the volume-based 50% cumulative particle diameter D_{w} (nm) of the wax particle is preferably 50 nm or more to 500 nm or less, more preferably 70 nm or more to 400 nm or less, particularly more preferably 100 nm or more to 300 nm or less. Further, the volume-based 50% cumulative particle diameter Dᵣ (nm) of the resin particle is preferably 40 nm or more to 400 nm or less, more preferably 50 nm or more to 300 nm or less, particularly preferably 50 nm or more to 200 nm or less. Those volume-based 50% cumulative particle diameters (D50) may be determined by a dynamic light scattering method. The volume-based 50% cumulative particle diameter is a particle diameter at which a cumulative volume from smaller particle diameters in a particle diameter cumulative curve becomes 50% based on the total volume of measured particles. The volume-based 50% cumulative particle diameters of the coloring material, the wax particle and the resin particle in Examples described below are each a value measured with a particle size analyzer (product name: “UPA-EX150”, manufactured by Nikkiso Co., Ltd.) based on a dynamic light scattering method.

(Relationship Among Contents of Coloring Material, Wax Particle and Resin Particle in Ink)

When the content (% by mass) of the coloring material, the content (% by mass) of the wax particle and the content (% by mass) of the resin particle in the aqueous ink are defined as C_{c}, C_{w} and Cᵣ, respectively, the aqueous ink preferably has a value for (C_{c}+C_{w})/Cᵣ of from 0.4 times or more to 4.0 times or less. When the value for (C_{c}+C_{w})/Cᵣ is 0.4 times or more, the glossiness of the image can be further improved. This is presumably because an influence of scattered light caused by the resin particle is reduced. In addition, when the value for (C_{c}+C_{w})/Cᵣ is 4.0 times or less, the abrasion resistance of the image can be further improved. This is presumably because the resin particle is present in a sufficient amount and hence the wax particles are more unevenly distributed.

[Aqueous Medium]

The ink is an aqueous ink including at least water as an aqueous medium. An aqueous medium that is the water or a mixed solvent of the water and a water-soluble organic solvent may be incorporated into the ink. Deionized water or ion-exchanged water is preferably used as the water. The content (% by mass) of the water in the aqueous ink is preferably 50.0% by mass or more to 95.0% by mass or less with respect to the total mass of the ink. In addition, the content (% by mass) of the water-soluble organic solvent in the aqueous ink is preferably 2.0% by mass or more to 40.0% by mass or less with respect to the total mass of the ink. Solvents that may be used in an ink for ink jet, such as alcohols, (poly)alkylene glycols, glycol ethers, nitrogen-containing compounds and sulfur-containing compounds, may each be used as the water-soluble organic solvent. The water-soluble organic solvents may be used alone or in combination thereof

[Water-Soluble Hydrocarbon Compound]

The water-soluble organic solvent to be incorporated into the ink preferably contains a specific water-soluble hydrocarbon compound. The water-soluble hydrocarbon compound is a compound having a hydrocarbon chain having 3 or more carbon atoms, the compound being substituted with 2 or more hydrophilic groups each selected from the group consisting of: a hydroxy group, an amino group, and an anionic group. However, the hydrocarbon chain may be interrupted by a sulfonyl group or an ether group. When the number of the carbon atoms of the hydrocarbon chain is 3 or 4, the hydrophilic groups include an anionic group or the hydrocarbon chain is interrupted by a sulfonyl group.

In the present invention, a hydrocarbon compound in the state of being dissolved in water at a content of the compound in the ink at 25° C. is defined as being “water-soluble”. That is, the solubility of the compound in water at 25° C. is larger than the content thereof in the ink. The fact that the hydrocarbon chain is interrupted by a sulfonyl group or an ether group means that a sulfonyl group (—S(═O)₂—) or an ether group (—O—) is present in the middle of the hydrocarbon chain. The water-soluble hydrocarbon compound has hydrogen-bonding groups, such as a hydroxy group, an amino group, an anionic group, a sulfonyl group and an ether group. Accordingly, the use of the ink including the hydrocarbon compound can suppress the cockling or curl of a recording medium having recorded thereon an image. A general hydrocarbon compound having a hydrocarbon chain having a relatively small number of carbon atoms (3 or 4 carbon atoms) tends to have a small molecular weight and hence have a low vapor pressure. However, the above-mentioned water-soluble hydrocarbon compound has a hydrogen-bonding anionic group or its hydrocarbon chain is interrupted by a sulfonyl group. Accordingly, the compound hardly evaporates owing to an intermolecular or intramolecular interaction and hence remains between fibers for forming the recording medium to exhibit a suppressing action on the cockling or the curl. The content (% by mass) of the water-soluble hydrocarbon compound in the ink is preferably 1.0% by mass or more to 20.0% by mass or less with respect to the total mass of the ink.

The number of the carbon atoms of the hydrocarbon chain for forming the water-soluble hydrocarbon compound is preferably 3 or more to 50 or less, more preferably 3 or more to 10 or less. Examples of the anionic group may include a sulfonic acid group and a carboxylic acid group. Specific examples of the water-soluble hydrocarbon compound may include: alkanediols, such as 1,5-pentanediol and 1,6-hexanediol, amino acids, such as alanine, β-alanine, trimethylglycine, amidosulfate (alias: sulfamic acid), aminomethanesulfonic acid, taurine (alias: 2-aminoethanesulfonic acid), carbamic acid, glycine, aspartic acid, glutamic acid, sulfanilic acid or salts of any of the acids described above, phenylalanine, leucine, isoleucine, threonine, tryptophan, valine, methionine, lysine and arginine, sulfonyl compounds such as bis(2-hydroxyethyl)sulfone, alkylene glycols, such as triethylene glycol, tetraethylene glycol, tripropylene glycol and a polyethylene glycol having a number-average molecular weight of from about 200 to about 1,000 and sugars, such as sorbitol, D-sorbitol, xylitol, trehalose, fructose and D(+)-xylose. The water-soluble hydrocarbon compounds may be used alone or in combination thereof

[Other Component]

The ink may include various additives, such as an antifoaming agent, a surfactant, a pH adjustor, a viscosity modifier, a rust inhibitor, an antiseptic, a fungicide, an antioxidant and an anti-reducing agent, as required in addition to the above-mentioned components. However, the ink is preferably free of the reactant to be used in the reaction liquid as described below.

[Physical Properties of Ink]

The ink is an aqueous ink to be applied to an ink jet system. Accordingly, from the viewpoint of reliability, it is preferred that the physical property values of the ink be appropriately controlled. Specifically, the surface tension of the ink at 25° C. is preferably 20 mN/m or more to 60 mN/m or less. In addition, the viscosity of the ink at 25° C. is preferably 1.0 mPa·s or more to 10.0 mPa·s or less. The pH of the ink at 25° C. is preferably 7.0 or more to 9.5 or less, more preferably 8.0 or more to 9.5 or less.

<Ink Jet Recording Method and Ink Jet Recording Apparatus>

The ink jet recording method according to one embodiment of the present invention and an ink jet recording apparatus that may be suitably used in the ink jet recording method are described below with reference to the drawings. The ink jet recording method of this embodiment is a method including ejecting the above-mentioned ink from a recording head of an ink jet system to record an image on a recording medium. The ink jet recording apparatus of the present embodiment is provided with the above-mentioned ink and an ink jet recording head for ejecting the ink.

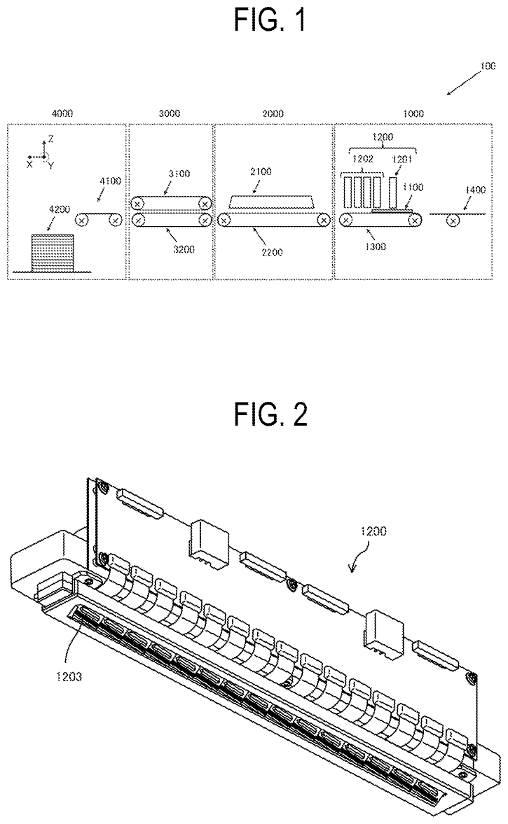

FIG. 1 is a schematic view for illustrating an example of the schematic configuration of an ink jet recording apparatus 100 of this embodiment. The ink jet recording apparatus 100 is an ink jet recording apparatus that records an image on a recording medium with a reaction liquid containing a reactant that reacts with an ink and the ink. Herein, description is given by taking a case in which the reaction liquid is used together with the ink as an example. However, the reaction liquid may not be used. An X-direction, a Y-direction and a Z-direction represent the width direction (total length direction), depth direction and height direction of the ink jet recording apparatus, respectively. The recording medium is conveyed in the X-direction.

The ink jet recording apparatus 100 of the embodiment illustrated in FIG. 1 includes: a recording portion 1000, a heating portion 2000, a fixing portion 3000, and a sheet delivery portion 4000. In the recording portion 1000, various liquids are applied to a recording medium 1100, which has been conveyed from a sheet feeding device 1400 by a conveying member 1300, by a liquid applying device 1200. In the heating portion 2000, the liquid components of an image formed by the liquids applied to the recording medium 1100 are evaporated and dried by heating with a heating device 2100. In the fixing portion 3000, a fixing member 3100 is brought into contact with the region of the recording medium 1100 including the image to heat the image, to thereby accelerate the fixation of the image to the recording medium 1100. After that, the recording medium 1100 is conveyed by the conveying member 4100 of the sheet delivery portion 4000 and is loaded and stored in a recording medium storage portion 4200. Herein, description is given by taking a configuration including the heating portion 2000 and the fixing portion 3000 as an example. However, the heating portion or the fixing portion may be omitted in accordance with recording conditions (e.g., the kinds of the ink and the recording medium and a recording speed). In Examples to be described later, recording was performed without use of the heating portion 2000 and the fixing portion 3000.

Any medium may be used as the recording medium 1100. For example, such recording media each having ink absorbability (permeability) as described below may each be used as the recording medium 1100: a recording medium free of a coating layer, such as plain paper, uncoated paper or synthetic paper and a recording medium including a coating layer, such as glossy paper or art paper. In addition, a recording medium that does not have permeability like a film or a sheet formed from a resin material, such as polyvinyl chloride (PVC) or polyethylene terephthalate (PET), may be used. The basis weight (g/m²) of the recording medium 1100 is preferably 30 g/m² or more to 500 g/m² or less, more preferably 50 g/m² or more to 450 g/m² or less.

[Recording Portion]

The recording portion 1000 includes the liquid applying device 1200. The liquid applying device 1200 includes a reaction liquid applying device 1201 and an ink applying device 1202. The reaction liquid applying device 1201 illustrated in FIG. 1 is an example of a unit using an ejection head of an ink jet system. The reaction liquid applying device may be formed by utilizing a gravure coater, an offset coater, a die coater, a blade coater or the like in addition to the ejection head. The reaction liquid may be applied by the reaction liquid applying device 1201 before the application of the ink or may be applied after the ink application as long as the liquid can be brought into contact with the ink on the recording medium 1100. However, to record a high-quality image on various recording media having different liquid-absorbing characteristics, the reaction liquid is preferably applied before the application of the ink. An ejection head (recording head) of an ink jet system is used as the ink applying device 1202. Examples of the ejection system of the ejection head serving as the liquid applying device 1200 include: a system including causing film boiling in a liquid with an electro-thermal converter to form air bubbles, to thereby eject the liquid and a system including ejecting the liquid with an electro-mechanical converter.

The liquid applying device 1200 is a line head arranged in the Y-direction in an extended manner and its ejection orifices are arrayed in a range covering the image recording region of the recording medium having the maximum usable width. The ejection head has an ejection orifice surface (not shown) having formed therein ejection orifices on its lower side (recording medium 1100 side). The ejection orifice surface faces the recording medium 1100 with a minute distance of about several millimeters therebetween.

The plurality of ink applying devices 1202 may be arranged for applying inks of respective colors to the recording medium 1100. For example, when respective color images are recorded with a yellow ink, a magenta ink, a cyan ink and a black ink, the four ink applying devices 1202 that eject the above-mentioned four kinds of inks are arranged side by side in the X-direction. The ink and the reaction liquid are hereinafter sometimes collectively referred to as “liquids”.

FIG. 2 is a perspective view for illustrating an example of the liquid applying device. The liquid applying device 1200 illustrated in FIG. 2 is a line head and a plurality of ejection element substrates 1203 having arranged therein ejection orifice arrays are linearly arrayed. The ejection element substrates 1203 each have arrayed therein a plurality of ejection orifice arrays.

[Conveyance System]

As illustrated in FIG. 1, the recording portion 1000 includes the liquid applying device 1200 and the conveying member 1300 that conveys the recording medium 1100. The reaction liquid and the ink are applied to the desired positions of the recording medium 1100, which is conveyed by the conveying member 1300, by the liquid applying device 1200. The respective liquid applying devices 1200 receive the image signal of recording data to apply the required reaction liquid and ink to the respective positions. Although the conveying member 1300 in the form of a conveying belt is illustrated in FIG. 1, for example, a spur or a conveying cylinder may be utilized as long as the spur or the cylinder has a function of conveying the recording medium 1100. A member that can fix the recording medium 1100 may be used as the conveying member 1300 for improving conveyance accuracy. Specific examples thereof may include: an approach including arranging holes in the conveying member 1300 and sucking the recording medium 1100 from its rear surface side to fix the recording medium and an approach including forming the conveying member 1300 from an appropriate material and electrostatically adsorbing the recording medium 1100 to fix the recording medium.

[Heating Portion]

As illustrated in FIG. 1, the heating portion 2000 includes the heating device 2100 and a conveying member 2200. The recording medium 1100 having recorded thereon the image through the application of the reaction liquid and the ink is heated by the heating device 2100 while being conveyed by the conveying member 2200. Thus, the liquid components of the image are evaporated and dried. The recording method preferably further includes, between the ink applying step and the fixing step, a drying step of subjecting the recording medium having applied thereto the ink to non-contact heating to dry the ink. The presence of such drying step can effectively suppress the deformation (cockling or curl) of the recording medium 1100.

The heating device 2100 may have any configuration as long as the device can heat the recording medium 1100. Conventionally known various devices, such as a warm-air dryer and a heater, may each be used. Of those, a non-contact-type heater, such as a heating wire and an infrared heater, is preferably utilized in terms of safety and energy efficiency. In addition, the utilization of the following mechanism easily improves the drying efficiency: the mechanism has built therein a fan for jetting a heated gas on the recording medium 1100 and blows warm air thereto.

With regard to a method for the heating, the recording medium 1100 may be heated from the side of the surface having applied thereto the reaction liquid and the ink, may be heated from its rear surface side or may be heated from both the surfaces. A heating function may be imparted to the conveying member 2200. Although the conveying member 2200 in the form of a conveying belt is illustrated in FIG. 1, for example, a spur or a conveying cylinder may be utilized as long as the spur or the cylinder has a function of conveying the recording medium 1100.

[Fixing Portion]

As illustrated in FIG. 1, in the fixing portion 3000, the recording medium 1100 is conveyed by a conveying member 3200. In addition, the fixing member 3100 is brought into contact with the recording medium 1100 under a state in which the recording medium is pressurized to heat the liquids applied to the recording medium 1100, such as the reaction liquid and the ink. Thus, an image can be fixed to the recording medium 1100. After the permeation of the liquid components of the reaction liquid and the ink into the recording medium 1100 having recorded thereon the image and the evaporation thereof from the recording medium 1100 by their passing through the heating portion 2000, the reaction liquid and the ink are fixed in the fixing portion 3000 to complete the image. When the recording medium 1100 is heated and pressurized under the state of being sandwiched between the fixing member 3100 and the conveying member 3200, the image on the recording medium 1100 and the fixing member 3100 are brought into close contact with each other and hence the image is fixed to the recording medium. When a liquid such as an ink containing the resin particle and a coloring material is used, the resin particle is softened through heating mainly by the fixing portion 3000 to form a film and hence the coloring material can be bound onto the recording medium 1100.

A method of heating the fixing member 3100 may be, for example, a system including arranging a heat source such as a halogen heater in each of rollers that drive the fixing member 3100 serving as a fixing belt to heat the member. In addition, the method may be, for example, a system including arranging a heat source such as an infrared heater at a site different from the fixing member 3100 to heat the member. Further, those systems may be combined with each other.

[Sheet Delivery Portion]

The recording medium 1100 after the image recording is stored in the sheet delivery portion 4000 (FIG. 1). Specifically, the recording medium 1100 after the recording is conveyed by the conveying member 4100 to be finally stored under the state of being loaded in the recording medium storage portion 4200. The two or more recording medium storage portions 4200 may be arranged for, for example, separately storing different recorded products.

(Reaction Liquid)

The recording method of the present invention preferably further includes, before an ink applying step, a reaction liquid applying step of applying an aqueous reaction liquid, which contains a reactant that reacts with the aqueous ink, to the recording medium. Respective components to be used in the reaction liquid and the like are described in detail below.

[Reactant]

The reaction liquid is brought into contact with the ink to react with the ink, to thereby aggregate components (a resin, a dispersant for dispersing wax, a surfactant, and a component having an anionic group such as a self-dispersible pigment) in the ink. The reaction liquid contains the reactant. When the reactant is present, at the time of contact between the ink and the reactant in the recording medium, the state of presence of the component having an anionic group in the ink is destabilized and hence the aggregation of the ink can be accelerated. Examples of the reactant may include: a polyvalent metal ion, a cationic component such as a cationic resin and an organic acid. The reactants may be used alone or in combination thereof.

Examples of the polyvalent metal ion forming a polyvalent metal salt may include: divalent metal ions, such as Ca²⁺, Cu²⁺, Ni²⁺, Mg²⁺, Sr²⁺, Ba²⁺ and Zn²⁺ and trivalent metal ions, such as Fe³⁺, Cr³⁺, Y³⁺ and Al³⁺. A water-soluble polyvalent metal salt (which may be a hydrate) made up of the polyvalent metal ion and an anion bonded to each other may be used to incorporate the polyvalent metal ion into the reaction liquid. Examples of such anion may include: inorganic anions, such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻ and organic anions, such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻. When the polyvalent metal ion is used as the reactant, its content (% by mass) in terms of polyvalent metal salt in the reaction liquid is preferably 1.0% by mass or more to 20.0% by mass or less with respect to the total mass of the reaction liquid. In this specification, when the polyvalent metal salt is a hydrate, the “content (% by mass) of the polyvalent metal salt” in the reaction liquid means the “content (% by mass) of the anhydride of the polyvalent metal salt” obtained by removing water serving as a hydrate.

The reaction liquid containing the organic acid has a buffering capacity in an acidic region (at a pH of less than 7.0, preferably at a pH of from 2.0 to 5.0) to efficiently turn the anionic group of the components present in the ink into an acid type, to thereby aggregate the ink. Examples of the organic acid may include: monocarboxylic acids, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumalic acid, and salts thereof, dicarboxylic acids, such as oxalic acid, malonic acid, succinic acid, glutaric acid, adipic acid, maleic acid, fumaric acid, itaconic acid, sebacic acid, phthalic acid, malic acid and tartaric acid, and salts and hydrogen salts thereof, tricarboxylic acids, such as citric acid and trimellitic acid, and salts and hydrogen salts thereof and tetracarboxylic acids such as pyromellitic acid, and salts and hydrogen salts thereof. When the organic acid is used as the reactant, the content (% by mass) of the organic acid in the reaction liquid is preferably 1.0% by mass or more to 50.0% by mass or less with respect to the total mass of the reaction liquid.

Examples of the cationic resin may include resins having structures of primary to tertiary amines and resins having structures of quaternary ammonium salts. Specific examples thereof may include resins having structures of, for example, vinylamine, allylamine, vinylimidazole, vinylpyridine, dimethylaminoethyl methacrylate, ethylene imine, guanidine, diallyldimethylammonium chloride and an alkylamine-epichlorohydrin condensate. To improve solubility in the reaction liquid, the cationic resin and an acidic compound may be used in combination or the cationic resin may be subjected to quaternization treatment. When the cationic resin is used as the reactant, the content (% by mass) of the cationic resin in the reaction liquid is preferably 0.1% by mass or more to 10.0% by mass or less with respect to the total mass of the reaction liquid.

[Aqueous Medium]

The reaction liquid is an aqueous reaction liquid containing at least water as an aqueous medium. Examples of the aqueous medium to be used in the reaction liquid may include the same examples as those of an aqueous medium that can be incorporated into the ink to be described above. The content (% by mass) of the water-soluble organic solvent in the reaction liquid is preferably 1.0% by mass or more to 45.0% by mass or less with respect to the total mass of the reaction liquid. The water-soluble organic solvent preferably contains a specific water-soluble hydrocarbon compound to be described above. The content (% by mass) of the water-soluble hydrocarbon compound in the reaction liquid is preferably 1.0% by mass or more to 20.0% by mass or less with respect to the total mass of the reaction liquid. In addition, the content (% by mass) of the water in the reaction liquid is preferably 50.0% by mass or more to 95.0% by mass or less with respect to the total mass of the reaction liquid.

[Other Component]

The reaction liquid may contain various other components as required. Examples of the other components may include the same examples as those of other components that can be incorporated into the ink to be described above. [Physical Properties of Reaction Liquid]

The reaction liquid is an aqueous reaction liquid to be applied to an ink jet system. Accordingly, from the viewpoint of reliability, it is preferred that the physical property values of the reaction liquid be appropriately controlled. Specifically, the surface tension of the reaction liquid at 25° C. is preferably 20 mN/m or more to 60 mN/m or less. In addition, the viscosity of the reaction liquid at 25° C. is preferably 1.0 mPa·s or more to 10.0 mPa·s or less. The pH of the reaction liquid at 25° C. is preferably 5.0 or more to 9.5 or less, more preferably 6.0 or more to 9.0 or less.

### EXAMPLES

The present invention is described in more detail below by way of Examples and Comparative Examples. The present invention is by no means limited to Examples below without departing from the gist of the present invention. “Part(s)” and “%” with regard to the description of the amounts of components are by mass, unless otherwise stated.

<Preparation of Pigment Dispersion Liquid>

(Pigment Dispersion Liquid 1)

A styrene-ethyl acrylate-acrylic acid copolymer (resin 1) having an acid value of 150 mg KOH/g and a weight-average molecular weight of 8,000 was prepared. 20.0 Parts of the resin 1 was neutralized with potassium hydroxide whose molar amount was equivalent to its acid value. In addition, an appropriate amount of pure water was added to the neutralized product to prepare an aqueous solution of the resin 1 in which the content of the resin (solid content) was 20.0%. 10.0 Parts of a pigment (solid solution pigment of C.I. Pigment Violet 19 and C.I. Pigment Red 122), 15.0 parts of the aqueous solution of the resin 1 and 75.0 parts of pure water were mixed to provide a mixture. The resulting mixture and 200 parts of 0.3 mm diameter zirconia bead were placed in a batch-type vertical sand mill (manufactured by AIMEX) and dispersed for 5 hours while cooling in water. After centrifugation to remove a coarse particle, the product was pressure filtered through a cellulose acetate filter having a pore size of 3.0 μm (manufactured by Advantec). In this way, pigment dispersion liquid 1 in which the content of the pigment (C.I. Pigment Red 122) was 10.0% and the content of the resin dispersant (resin 1) was 3.0%, was prepared. The pigment had a volume-average particle diameter (D50) of 130 nm.

(Pigment Dispersion Liquid 2)

A pigment dispersion liquid 2 having a pigment (C.I. Pigment Red 150) content of 10.0% and a resin dispersant (Resin 1) content of 3.0% was prepared by the same procedure as that of the above-mentioned pigment dispersion liquid 1 except that the pigment was changed to C.I. Pigment Red 150. The pigment had a volume-average particle diameter (D50) of 130 nm.

(Pigment Dispersion Liquid 3)

A pigment dispersion liquid 3 having a pigment (C.I. Pigment Blue 15:3) content of 10.0% and a resin dispersant (Resin 1) content of 3.0% was prepared by the same procedure as that of the above-mentioned pigment dispersion liquid 1 except that the pigment was changed to C.I. Pigment Blue 15:3. The pigment had a volume-average particle diameter (D50) of 130 nm.

(Pigment Dispersion Liquid 4)

A pigment dispersion liquid 4 having a pigment (C.I. Pigment Red 122) content of 10.0% and a resin dispersant (Resin 1) content of 3.0% was prepared by the same procedure as that of the above-mentioned pigment dispersion liquid 1 except that the pigment was changed to C.I. Pigment Red 122. The pigment had a volume-average particle diameter (D50) of 130 nm.

(Pigment Dispersion Liquid 5)

A pigment dispersion liquid 5 having a pigment (C.I. Pigment Yellow 74) content of 10.0% and a resin dispersant (Resin 1) content of 3.0% was prepared by the same procedure as that of the above-mentioned pigment dispersion liquid 1 except that the pigment was changed to C.I. Pigment Yellow 74. The pigment had a volume-average particle diameter (D50) of 130 nm.

(Pigment Dispersion Liquid 6)

1.80 Grams of 4-amino-1,2-benzenedicarboxylic acid was added at a temperature of 5° C. to a solution obtained by dissolving 5.00 g of concentrated hydrochloric acid in 5.50 g of water. While the solution obtained in the foregoing was stirred in an ice bath so that a temperature of 10° C. or less was kept, a solution obtained by dissolving 0.90 g of sodium nitrite in 9.00 g of water was added thereto. After the mixture was stirred for 15 minutes, 6.00 g of pigment (carbon black) having a specific surface area of 254 m²/g and a DBP oil absorption of 180 mL/100 g was added thereto and mixed therewith. After the mixture was stirred for another 15 minutes, the resultant slurry was filtered through filter paper (standard filter paper No. 2, manufactured by Advantec) and the carbon black was sufficiently washed with water, followed by drying in an oven at a temperature of 110° C. Water was added to the resultant carbon black. Thus, a pigment dispersion liquid 6 having a content of the pigment (carbon black) of 10.0% was obtained. The pigment dispersion liquid 6 included a self-dispersible pigment in which a —C₆H₃—(COONa)₂ group was bonded to a particle surface. The pigment had a volume-average particle diameter (D50) of 100 nm.

(Pigment Dispersion Liquid 7)

A pigment dispersion liquid 7 having a pigment (carbon black) content of 10.0% and a resin dispersant (Resin 1) content of 3.0% was prepared by the same procedure as that of the above-mentioned pigment dispersion liquid 1 except that the pigment was changed to a carbon black having a specific volume-average particle diameter. The pigment had a volume-average particle diameter (D50) of 100 nm.

(Pigment Dispersion Liquid 8)

A pigment dispersion liquid 8 having a pigment (carbon black) content of 10.0% and a resin dispersant (Resin 1) content of 3.0% was prepared by the same procedure as that of the above-mentioned pigment dispersion liquid 1 except that the pigment was changed to a carbon black having a specific volume-average particle diameter. The pigment had a volume-average particle diameter (D50) of 90 nm.

(Pigment Dispersion Liquid 9)

A pigment dispersion liquid 9 having a pigment (carbon black) content of 10.0% and a resin dispersant (Resin 1) content of 3.0% was prepared by the same procedure as that of the above-mentioned pigment dispersion liquid 1 except that the pigment was changed to a carbon black having a specific volume-average particle diameter. The pigment had a volume-average particle diameter (D50) of 80 nm.

(Pigment Dispersion Liquid 10)

A mixture was obtained by mixing 30.0 parts of a pigment, 4.0 parts of a dispersant, 0.2 part of a defoaming agent (product name: “Surfynol 104E”, manufactured by Nissin Chemical Co., Ltd.) and 70.8 parts of ion exchanged water. Carbon black (product name: “MCF #1000”, manufactured by Mitsubishi Chemical Corporation) was used as the pigment. In addition, a nonionic surfactant (product name: “NIKKOL BC-10”, manufactured by Nikko Chemicals Co., Ltd., polyoxyethylene cetyl ether [number of ethylene oxide groups: 10]) was used as the dispersant. The resultant mixture was filled into a paint shaker (manufactured by Toyo Seiki Seisaku-sho, Ltd.) filled with zirconia beads each having a diameter of 0.3 mm and was subjected to dispersion treatment for 60 minutes. Thus, a pigment dispersion liquid 10 having a content of the pigment of 10.0% and a content of the dispersant (surfactant) of 4.0% was obtained. The pigment had a volume-average particle diameter (D50) of 130 nm.

<Preparation of Resin Particle>

(Resin Particles 1 to 10)

Acrylonitrile (AN), methacrylonitrile (MAN), chloroacrylonitrile (CAN), styrene (St), a reactive surfactant, ethyl methacrylate (EMA) and methacrylic acid (MAA) were prepared as monomers. In each of resin particles 1 to 7 and 10, an ether sulfate-type ammonium salt (product name: “ADEKA REASOAP SR-10”, manufactured by ADEKA Corporation; represented as “SR-10”) for forming a unit having a sulfate ester group was used as the reactive surfactant. In addition, in each of resin particles 8 and 9, an alkoxy polyethylene glycol methacrylate (product name: “Antox LMA-10”, manufactured by Nippon Nyukazai Co., Ltd.; represented as “LMA-10”) was used as the reactive surfactant.

A reaction vessel mounted with a stirring device was set in a hot water bath. 1,178 Parts of water was filled into the reaction vessel and a temperature therein was held at 70° C. Monomers whose loading amounts (unit: part(s)) were shown in Table 1 were mixed to prepare a monomer mixed liquid. In addition, 1.9 parts of potassium persulfate and 659 parts of water were mixed to prepare an aqueous solution of the polymerization initiator. The monomer mixed liquid and the aqueous solution of the polymerization initiator were dropped in parallel into the reaction vessel over 60 minutes. After the completion of the dropping, the mixture was further subjected to a reaction for 30 minutes while being continuously stirred. Thus, resin particles were synthesized. After that, an appropriate amount of an 8 mol/L aqueous solution of potassium hydroxide was added into the reaction vessel to adjust the pH of the liquid to 8.5. An appropriate amount of water was further added to provide an aqueous dispersion liquid of each of the resin particles in which the content and volume-based 50% cumulative particle diameter (D50) of the resin particle were 20.0% and 100 nm, respectively. The volume-based 50% cumulative particle diameters (D50) of the resin particles were each measured with a particle size analyzer of a dynamic light scattering system (product name: “UPA-EX150”, manufactured by Nikkiso Co., Ltd.) under the following conditions: SetZero: 30 seconds, number of times of measurement: 3 times, measurement time: 180 seconds, shape: perfect spherical shape and refractive index: 1.59.

TABLE 1
Synthesis conditions of resin particles

| | | | | | | | | | Volume |
|---|---|---|---|---|---|---|---|---|---|
| | | | | | | | | | average |
| | | | | | | | | | particle |
| Resin | Loading amount of monomers (parts) | | | | | | | | diameter |
| particle | AN | MAN | CAN | St | SR-10 | LMA-10 | EMA | MAA | (nm) |
| 1 | 30.0 | | | 45.0 | 5.0 | | | 20.0 | 100 |
| 2 | 5.0 | | | 70.0 | 5.0 | | | 20.0 | 100 |
| 3 | 10.0 | | | 65.0 | 5.0 | | | 20.0 | 100 |
| 4 | 40.0 | | | 35.0 | 5.0 | | | 20.0 | 100 |
| 5 | | 30.0 | | 45.0 | 5.0 | | | 20.0 | 100 |
| 6 | | | 30.0 | 45.0 | 5.0 | | | 20.0 | 100 |
| 7 | 30.0 | | | | 5.0 | | 45.0 | 20.0 | 100 |
| 8 | 30.0 | | | 45.0 | | 5.0 | | 20.0 | 100 |
| 9 | | | 5.0 | | | 5.0 | 70.0 | 20.0 | 100 |
| 10 | | | | 75.0 | 5.0 | | | 20.0 | 100 |

<Preparation of Wax Particle>

(Wax Particles 1 to 12)

A wax whose kind and acid value were shown in Table 2, a dispersant, an aqueous solution of potassium hydroxide and ion exchanged water were added to a vessel mounted with a stirring device, a temperature gauge and a temperature controller. A temperature was increased to 160° C. and the contents were stirred for 2 hours. A nonionic surfactant (product name: “NIKKOL BC-10”, manufactured by Nikko Chemicals Co., Ltd., polyoxyethylene cetyl ether [number of ethylene oxide groups: 10]) was used as the dispersant. In this case, the stirring conditions were adjusted so that the volume-average particle diameter (D50) of a wax particle obtained by dispersing the wax by the dispersant had the value shown in Table 2. After that, the temperature was cooled to 40° C. Thus, an aqueous dispersion of each of wax particles 1 to 12 having a content (solid content) of the wax particle of 20.0% was prepared.

TABLE 2
Preparation conditions and Properties of dispersion of wax particles

| | | | Volume average |
|---|---|---|---|
| Wax | | Acid value | particle diameter |
| particle | Wax | (mgKOH/g) | (nm) |
| 1 | Fischer Tropsch Wax | 10 | 200 |
| 2 | Polyethylene wax | 10 | 200 |
| 3 | Fischer Tropsch Wax | 0 | 200 |
| 4 | Fischer Tropsch Wax | 3 | 200 |
| 5 | Fischer Tropsch Wax | 5 | 200 |
| 6 | Fischer Tropsch Wax | 50 | 200 |
| 7 | Fischer Tropsch Wax | 10 | 105 |
| 8 | Fischer Tropsch Wax | 10 | 100 |
| 9 | Fischer Tropsch Wax | 10 | 130 |
| 10 | Fischer Tropsch Wax | 10 | 110 |
| 11 | Fischer Tropsch Wax | 10 | 90 |
| 12 | Fischer Tropsch Wax | 10 | 80 |

(Wax Particle 13)

A soap-free-type wax emulsion was obtained with reference to the description of Example 1 of Japanese Patent Application Laid-Open No. 2003-147088. 30.0 Parts of candelilla wax having an acid value of 20 mgKOH/g, a saponification value of 50 mgKOH/g and a melting point of 71° C. was dissolved at 90° C. and 0.3 part of morpholine was added thereto. Under stirring, phase inversion emulsification was performed by gradually adding 70.0 parts of hot water at 90° C. thereto. After that, a crude emulsion was stirred at 3,000 rpm with a homomixer (product name: “T.K. HOMOMIXER”, manufactured by Tokushu Kika Kogyo Co., Ltd.) while its temperature was retained. Next, the emulsion was treated with a homogenizer (product name: “15MR-STA”, manufactured by APV GAULIN, INC.) at 400 kg/cm². Further, under stirring, the temperature was cooled to 38° C. Thus, an aqueous dispersion of a wax particle 13 including a wax particle dispersed without a dispersant and having a content (solid content) of the wax particle of 20.0% was prepared. The wax particle 13 had a volume-based 50% cumulative particle diameter (D50) of 200 nm.

(Wax Particle 14)

An aqueous dispersion of a wax particle 14 having a content (solid content) of a wax particle of 20.0% was prepared by diluting an aqueous dispersion of a polyethylene wax particle (product name: “HYTEC E-6500”, manufactured by TOHO Chemical Industry Co., Ltd., solid content: 35%) with ion exchanged water. The wax particle 14 had a volume-based 50% cumulative particle diameter (D50) of 60 nm.

<Preparation of Ink>

Respective components (unit: %) shown in the middle column of Table 3 (Tables 3-1 to 3-4) were mixed and sufficiently stirred, followed by filtration with a cellulose acetate filter having a pore size of 3.0 μm (manufactured by Advantec) under pressure. Products whose numbers were shown in the upper sections of Tables 3 were used as a pigment dispersion liquid, a water dispersion liquid of a resin particle and a water dispersion liquid of a wax particle. The term “ACETYLENOL E100” shown in Table 3 represents the product name of a surfactant manufactured by Kawaken Fine Chemicals Co., Ltd. The volume-based 50% cumulative particle diameter (D50) of the coloring material (D_{c}), resin particle (Dᵣ), and wax particle (D_{w}) were shown as ink characteristics in the lower section of each of Tables 3. In addition, the values of the coloring material content C_{c}, the resin particle content Cᵣ, and the wax particle content C_{w}, and (C_{c}+C_{w})/Cᵣ with respect to the total mass of the ink were shown.

TABLE 3-1
Composition and property of Inks

| | Example | | | | | | | | | | |
|---|---|---|---|---|---|---|---|---|---|---|---|
| | 1 | 2 | 3 | 4 | 5 | 6 | 7 | 8 | 9 | 10 | 11 |
| Type of pigment dispersion | 1 | 1 + 2 | 3 | 4 | 5 | 6 | 1 | 1 | 1 | 1 | 1 |
| liquid (No.) | | | | | | | | | | | |
| Type of resin particle (No.) | 1 | 1 | 1 | 1 | 1 | 1 | 1 | 2 | 3 | 4 | 5 |
| Type of wax particle (No.) | 1 | 1 | 1 | 1 | 1 | 1 | 2 | 1 | 1 | 1 | 1 |
| Pigment dispersion liquid | 30.0 | 22.5 + 7.5 | 30.0 | 30.0 | 30.0 | 30.0 | 30.0 | 30.0 | 30.0 | 30.0 | 30.0 |
| Water dispersion liquid of resin | 25.0 | 25.0 | 25.0 | 25.0 | 25.0 | 25.0 | 25.0 | 25.0 | 25.0 | 25.0 | 25.0 |
| particle | | | | | | | | | | | |
| Water dispersion liquid of wax | 15.0 | 15.0 | 15.0 | 15.0 | 15.0 | 15.0 | 15.0 | 15.0 | 15.0 | 15.0 | 15.0 |
| particle | | | | | | | | | | | |
| Glycerin | 19.0 | 19.0 | 19.0 | 19.0 | 19.0 | 19.0 | 19.0 | 19.0 | 19.0 | 19.0 | 19.0 |
| ACETYLENOL E100 | 0.5 | 0.5 | 0.5 | 0.5 | 0.5 | 0.5 | 0.5 | 0.5 | 0.5 | 0.5 | 0.5 |
| Ion-exchanged water | 10.5 | 10.5 | 10.5 | 10.5 | 10.5 | 10.5 | 10.5 | 10.5 | 10.5 | 10.5 | 10.5 |
| D_{c} of coloring material (nm) | 130 | 130 | 130 | 130 | 130 | 100 | 130 | 130 | 130 | 130 | 130 |
| Dᵣ of resin particle (nm) | 100 | 100 | 100 | 100 | 100 | 100 | 100 | 100 | 100 | 100 | 100 |
| D_{w} of wax particle (nm) | 200 | 200 | 200 | 200 | 200 | 200 | 200 | 200 | 200 | 200 | 200 |
| Coloring material content C_{c} (%) | 3.0 | 3.0 | 3.0 | 3.0 | 3.0 | 3.0 | 3.0 | 3.0 | 3.0 | 3.0 | 3.0 |
| Resin particle content Cᵣ (%) | 5.0 | 5.0 | 5.0 | 5.0 | 5.0 | 5.0 | 5.0 | 5.0 | 5.0 | 5.0 | 5.0 |
| Wax particle content C_{w} (%) | 3.0 | 3.0 | 3.0 | 3.0 | 3.0 | 3.0 | 3.0 | 3.0 | 3.0 | 3.0 | 3.0 |
| Value of (C_{c} + C_{w})/Cᵣ (times) | 1.2 | 1.2 | 1.2 | 1.2 | 1.2 | 1.2 | 1.2 | 1.2 | 1.2 | 1.2 | 1.2 |

TABLE 3-2
Composition and property of Inks

| | Example | | | | | | | | | | |
|---|---|---|---|---|---|---|---|---|---|---|---|
| | 12 | 13 | 14 | 15 | 16 | 17 | 18 | 19 | 20 | 21 | 22 |
| Type of pigment dispersion | 1 | 1 | 1 | 1 | 1 | 1 | 1 | 7 | 7 | 8 | 1 |
| liquid (No.) | | | | | | | | | | | |
| Type of resin particle (No.) | 6 | 7 | 8 | 1 | 1 | 1 | 1 | 1 | 1 | 1 | 1 |
| Type of wax particle (No.) | 1 | 1 | 1 | 3 | 4 | 5 | 6 | 1 | 7 | 1 | 1 |
| Pigment dispersion liquid | 30.0 | 30.0 | 30.0 | 30.0 | 30.0 | 30.0 | 30.0 | 30.0 | 30.0 | 30.0 | 10.0 |
| Water dispersion liquid of resin | 25.0 | 25.0 | 25.0 | 25.0 | 25.0 | 25.0 | 25.0 | 25.0 | 25.0 | 25.0 | 30.0 |
| particle | | | | | | | | | | | |
| Water dispersion liquid of wax | 15.0 | 15.0 | 15.0 | 15.0 | 15.0 | 15.0 | 15.0 | 15.0 | 15.0 | 15.0 | 5.0 |
| particle | | | | | | | | | | | |
| Glycerin | 19.0 | 19.0 | 19.0 | 19.0 | 19.0 | 19.0 | 19.0 | 19.0 | 19.0 | 19.0 | 19.0 |
| ACETYLENOL E100 | 0.5 | 0.5 | 0.5 | 0.5 | 0.5 | 0.5 | 0.5 | 0.5 | 0.5 | 0.5 | 0.5 |
| Ion-exchanged water | 10.5 | 10.5 | 10.5 | 10.5 | 10.5 | 10.5 | 10.5 | 10.5 | 10.5 | 10.5 | 35.5 |
| D_{c} of coloring material (nm) | 130 | 130 | 130 | 130 | 130 | 130 | 130 | 100 | 100 | 90 | 130 |
| Dᵣ of resin particle (nm) | 100 | 100 | 100 | 100 | 100 | 100 | 100 | 100 | 100 | 100 | 100 |
| D_{w} of wax particle (nm) | 200 | 200 | 200 | 200 | 200 | 200 | 200 | 200 | 105 | 200 | 200 |
| Coloring material content C_{c} (%) | 3.0 | 3.0 | 3.0 | 3.0 | 3.0 | 3.0 | 3.0 | 3.0 | 3.0 | 3.0 | 1.0 |
| Resin particle content Cᵣ (%) | 5.0 | 5.0 | 5.0 | 5.0 | 5.0 | 5.0 | 5.0 | 5.0 | 5.0 | 5.0 | 6.0 |
| Wax particle content C_{w} (%) | 3.0 | 3.0 | 3.0 | 3.0 | 3.0 | 3.0 | 3.0 | 3.0 | 3.0 | 3.0 | 1.0 |
| Value of (C_{c} + C_{w})/Cᵣ (times) | 1.2 | 1.2 | 1.2 | 1.2 | 1.2 | 1.2 | 1.2 | 1.2 | 1.2 | 1.2 | 0.3 |

TABLE 3-3
Composition and property of Inks

| | Example | | | | Comparative example | | | | | |
|---|---|---|---|---|---|---|---|---|---|---|
| | 23 | 24 | 25 | 26 | 1 | 2 | 3 | 4 | 5 | 6 |
| Type of pigment dispersion | 1 | 1 | 1 | 8 | 10 | 1 | 1 | 1 | 1 | 7 |
| liquid (No.) | | | | | | | | | | |
| Type of resin particle (No.) | 1 | 1 | 1 | 9 | 1 | — | 10 | 1 | 1 | 1 |
| Type of wax particle (No.) | 1 | 1 | 1 | 4 | 1 | 1 | 1 | — | 13 | 8 |
| Pigment dispersion liquid | 10.0 | 30.0 | 30.0 | 30.0 | 30.0 | 30.0 | 30.0 | 30.0 | 30.0 | 30.0 |
| Water dispersion liquid of resin | 25.0 | 10.0 | 10.0 | 10.0 | 25.0 | — | 25.0 | 25.0 | 25.0 | 25.0 |
| particle | | | | | | | | | | |
| Water dispersion liquid of wax | 5.0 | 25.0 | 30.0 | 35.0 | 15.0 | 15.0 | 15.0 | — | 15.0 | 15.0 |
| particle | | | | | | | | | | |
| Glycerin | 19.0 | 19.0 | 19.0 | 19.0 | 19.0 | 19.0 | 19.0 | 19.0 | 19.0 | 19.0 |
| ACETYLENOL E100 | 0.5 | 0.5 | 0.5 | 0.5 | 0.5 | 0.5 | 0.5 | 0.5 | 0.5 | 0.5 |
| Ion-exchanged water | 40.5 | 15.5 | 10.5 | 5.5 | 10.5 | 35.5 | 10.5 | 25.5 | 10.5 | 10.5 |
| D_{c} of coloring material (nm) | 130 | 130 | 130 | 90 | 130 | 130 | 130 | 130 | 130 | 100 |
| Dᵣ of resin particle (nm) | 100 | 100 | 100 | 100 | 100 | 100 | 100 | 100 | 100 | 100 |
| D_{w} of wax particle (nm) | 200 | 200 | 200 | 200 | 200 | 200 | 200 | — | 200 | 100 |
| Coloring material content C_{c} (%) | 1.0 | 3.0 | 3.0 | 3.0 | 3.0 | 3.0 | 3.0 | 3.0 | 3.0 | 3.0 |
| Resin particle content Cᵣ (%) | 5.0 | 2.0 | 2.0 | 2.0 | 5.0 | 0.0 | 5.0 | 5.0 | 5.0 | 5.0 |
| Wax particle content C_{w} (%) | 1.0 | 5.0 | 6.0 | 7.0 | 3.0 | 3.0 | 3.0 | 0.0 | 3.0 | 3.0 |
| Value of (C_{c} + C_{w})/Cᵣ (times) | 0.4 | 4.0 | 4.5 | 5.0 | 1.2 | — | 1.2 | 0.6 | 1.2 | 1.2 |

TABLE 3-4
Composition and property of Inks

| | Comparative example | | | | | | | | | |
|---|---|---|---|---|---|---|---|---|---|---|
| | 7 | 8 | 9 | 10 | 11 | 12 | 13 | 14 | 15 | 16 |
| Type of pigment dispersion | 1 | 8 | 1 | 1 | 8 | 9 | 7 | 8 | 1 | 1 |
| liquid (No.) | | | | | | | | | | |
| Type of resin particle (No.) | 1 | 1 | 1 | 1 | 1 | 1 | 1 | 1 | 1 | 10 |
| Type of wax particle (No.) | 9 | 8 | 8 | 10 | 11 | 11 | 11 | 12 | 11 | 14 |
| Pigment dispersion liquid | 30.0 | 30.0 | 30.0 | 30.0 | 30.0 | 30.0 | 30.0 | 30.0 | 30.0 | 30.0 |
| Water dispersion liquid of resin | 25.0 | 25.0 | 25.0 | 25.0 | 25.0 | 25.0 | 25.0 | 25.0 | 25.0 | 25.0 |
| particle | | | | | | | | | | |
| Water dispersion liquid of wax | 15.0 | 15.0 | 15.0 | 15.0 | 15.0 | 15.0 | 15.0 | 15.0 | 15.0 | 15.0 |
| particle | | | | | | | | | | |
| Glycerin | 19.0 | 19.0 | 19.0 | 19.0 | 19.0 | 19.0 | 19.0 | 19.0 | 19.0 | 19.0 |
| ACETYLENOL E100 | 0.5 | 0.5 | 0.5 | 0.5 | 0.5 | 0.5 | 0.5 | 0.5 | 0.5 | 0.5 |
| Ion-exchanged water | 10.5 | 10.5 | 10.5 | 10.5 | 10.5 | 10.5 | 10.5 | 10.5 | 10.5 | 10.5 |
| D_{c} of coloring material (nm) | 130 | 90 | 130 | 130 | 90 | 80 | 100 | 90 | 130 | 130 |
| Dᵣ of resin particle (nm) | 100 | 100 | 100 | 100 | 100 | 100 | 100 | 100 | 100 | 100 |
| D_{w} of wax particle (nm) | 130 | 100 | 100 | 110 | 90 | 90 | 90 | 80 | 90 | 60 |
| Coloring material content C_{c} (%) | 3.0 | 3.0 | 3.0 | 3.0 | 3.0 | 3.0 | 3.0 | 3.0 | 3.0 | 3.0 |
| Resin particle content Cᵣ (%) | 5.0 | 5.0 | 5.0 | 5.0 | 5.0 | 5.0 | 5.0 | 5.0 | 5.0 | 5.0 |
| Wax particle content C_{w} (%) | 3.0 | 3.0 | 3.0 | 3.0 | 3.0 | 3.0 | 3.0 | 3.0 | 3.0 | 3.0 |
| Value of (C_{c} + C_{w})/Cᵣ (times) | 1.2 | 1.2 | 1.2 | 1.2 | 1.2 | 1.2 | 1.2 | 1.2 | 1.2 | 1.2 |

<Evaluation>

The prepared inks were used and each filled into the ink jet recording apparatus 100 having a configuration illustrated in FIG. 1. A solid image measuring 2 cm by 2 cm, the image having an ink recording duty of 100%, was recorded on glossy paper (product name: “Canon Photo Paper Glossy Gold”, manufactured by Canon Inc.) with the above-mentioned ink jet recording apparatus 100. In this Example, an image recorded under the following conditions is defined as having a recording duty of 100%: one ink droplet having a mass of 3.0 ng is applied to a unit region measuring 1/1,200 inch by 1/1,200 inch. In this Example, in evaluation criteria for each of the following items, while ranks “A” and “B” were defined as acceptable levels, ranks “C” was defined as an unacceptable level. The evaluation results are shown in Table 4.

(Glossiness)

Fluorescent light was projected on the recorded solid image from a position at a distance of 50 cm. The width (represented as W1) of an image of the fluorescent light projected on the solid image was measured under the conditions of a lighting angle of 45 degrees and an observation angle of 45 degrees. In addition, the fluorescent light was projected on a non-recording portion of a recording medium under the same conditions and the width (represented as W2) of an image of the fluorescent light was measured. The glossiness of the image was evaluated in accordance with the following evaluation criteria based on a ratio between W1 and W2 obtained.

A: The ratio of W1/W2 was 5.0 or less.

B: The ratio of W1/W2 was more than 5.0 to 8.0 or less.

C: The ratio of W1/W2 was more than 8.0.

(Abrasion Resistance)

One minute after the recording, the recorded solid image was subjected to a friction test with a wear resistance tester (manufactured by Imoto Machinery Co., Ltd.) that was a gakushin-type tester in conformity with JIS L 0849 under the following conditions: the image was reciprocally rubbed with a load of 200 g for 3 times or 5 times. The solid image after the friction test was visually observed and the abrasion resistance of the image was evaluated in accordance with the following evaluation criteria.

A: The solid image was not scraped even after the 5 reciprocations.

B: The solid image was not scraped after the 3 reciprocations but the solid image was scraped to show the white ground of the recording medium after the 5 reciprocations.

C: The solid image was scraped to show the white ground of the recording medium after the 3 reciprocations.

TABLE 4
Conditions and results of evaluation

| | | | Abration |
|---|---|---|---|
| | | Glossiness | resistance |
| Example | 1 | A | A |
| | 2 | A | A |
| | 3 | A | A |
| | 4 | A | A |
| | 5 | A | A |
| | 6 | A | A |
| | 7 | A | A |
| | 8 | B | A |
| | 9 | A | A |
| | 10 | A | A |
| | 11 | A | A |
| | 12 | B | A |
| | 13 | A | B |
| | 14 | A | B |
| | 15 | B | A |
| | 16 | B | A |
| | 17 | A | A |
| | 18 | A | A |
| | 19 | A | A |
| | 20 | A | A |
| | 21 | B | A |
| | 22 | B | A |
| | 23 | A | A |
| | 24 | A | A |
| | 25 | A | B |
| | 26 | B | B |
| Comparative | 1 | C | C |
| Example | 2 | C | C |
| | 3 | C | B |
| | 4 | B | C |
| | 5 | C | C |
| | 6 | B | C |
| | 7 | B | C |
| | 8 | B | C |
| | 9 | B | C |
| | 10 | B | C |
| | 11 | B | C |
| | 12 | B | C |
| | 13 | B | C |
| | 14 | B | C |
| | 15 | B | C |
| | 16 | C | C |

According to the present invention, there can be provided the aqueous ink that can record an image with excellent abrasion resistance and gloss immediately after recording. In addition, according to the present invention, the ink jet recording method and the ink jet recording apparatus using the aqueous ink can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-167227, filed Oct. 18, 2022, and Japanese Patent Application No. 2023-171092, filed Oct. 2, 2023, which are hereby incorporated by reference herein in their entirety.

What is claimed is:

1. An aqueous ink for ink jet comprising:
a coloring material dispersed by an action of an anionic group;
a resin particle; and
a wax particle dispersed by a dispersant,
wherein a resin for forming the resin particle comprises a unit having a cyano group, and
wherein a volume-based 50% cumulative particle diameter D_{w} of the wax particle is larger than a volume-based 50% cumulative particle diameter D_{c} of the coloring material and a volume-based 50% cumulative particle diameter Dᵣ of the resin particle.

2. The aqueous ink according to claim 1, wherein a ratio (% by mass) of the unit having a cyano group to the resin for forming the resin particle is 10.0% by mass or more with respect to a total mass of the resin.

3. The aqueous ink according to claim 1, wherein the unit having a cyano group is a unit derived from at least one kind of monomer selected from the group consisting of: acrylonitrile and methacrylonitrile.

4. The aqueous ink according to claim 1, wherein the resin for forming the resin particle comprises a unit having an aromatic group.

5. The aqueous ink according to claim 1, wherein the resin for forming the resin particle comprises a unit having a sulfate ester group.

6. The aqueous ink according to claim 1, wherein the wax particle has an acid value of 5 mgKOH/g or more.

7. The aqueous ink according to claim 1, wherein the volume-based 50% cumulative particle diameter D_{c} of the coloring material, the volume-based 50% cumulative particle diameter D_{w} of the wax particle and the volume-based 50% cumulative particle diameter Dᵣ of the resin particle satisfy the following relationship: Dᵣ≤D_{c}<D_{w}.

8. The aqueous ink according to claim 1, wherein, when a content (% by mass) of the coloring material, a content (% by mass) of the wax particle and a content (% by mass) of the resin particle in the aqueous ink are defined as C_{c}, C_{w} and Cᵣ, respectively, the aqueous ink has a value for (C_{c}+C_{w})/Cᵣ of from 0.4 times or more to 4.0 times or less.

9. An ink jet recording method comprising ejecting an ink from a recording head of an ink jet system to record an image on a recording medium,
wherein the ink comprises the aqueous ink of claim 1.

10. An ink jet recording apparatus comprising:
an ink and
a recording head of an ink jet system configured to eject the ink,
wherein the ink comprises the aqueous ink of claim 1.
